(19) United States
(12) Patent Application Publication
(10) Pub. No.: US 2024/0022361 A1
(43) Pub. Date: Jan. 18, 2024

(54) ESTIMATING REPETITIONS REQUIRED

(71) Applicant: NOKIA TECHNOLOGIES OY, Espoo (FI)

(72) Inventors: Jeroen WIGARD, Klarup (DK); Rapeepat RATASUK, Inverness, IL (US); Mads LAURIDSEN, Gistrup (DK); Frank FREDERIKSEN, Klarup (DK)

(73) Assignee: NOKIA TECHNOLOGIES OY, Espoo (FI)

(21) Appl. No.: 18/254,746

(22) PCT Filed: Nov. 19, 2021
(86) PCT No.: PCT/FI2021/050791

§ 371 Date: May 26, 2023

(30) Foreign Application Priority Data
Nov. 27, 2020 (FI) 20206214

(51) Int. Cl. H04L 1/1867

(52) U.S. Cl. CPC H04L 1/189

(57) ABSTRACT

Disclosed is a method comprising receiving a data packet from an access node, combining the received data packet with previous repetitions of the data packet to obtain a combined data packet, attempting to decode information comprised in the combined data packet, determining that the attempt to decode was not successful, determining an estimate of energy required for a correct reception of the data packet and based, at least partly, on the determined estimation for the energy, determining an additional number of repetitions of the data packet.

### FIELD

The following exemplary embodiments relate to wireless communication and receiving transmissions.

### BACKGROUND

Wireless communication networks, such as cellular communication networks, allows devices to freely move from one area to another. Data transmitted using wireless communication network is however susceptible to various kinds of interference thereby risking the successful reception of the transmitted data. Therefore, it is desirable to ensure that data transmitted may be received successfully by a receiving apparatus.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for receiving a data packet from an access node, combining the received data packet with previous repetitions of the data packet to obtain a combined data packet, attempting to decode information comprised in the combined data packet, determining that the attempt to decode was not successful, determining an estimate of energy required for a correct reception of the data packet and based, at least partly, on the determined estimation for the energy, determining an additional number of repetitions of the data packet.

According to a second aspect there is provided an apparatus comprising at least one processor, and at least one memory including a computer program code, wherein the at least one memory and the computer program code are configured, with the at least one processor, to cause the apparatus to receive a data packet from an access node, combine the received data packet with previous repetitions of the data packet to obtain a combined data packet, attempt to decode information comprised in the combined data packet, determine that the attempt to decode was not successful, determine an estimate of energy required for a correct reception of the data packet and based, at least partly, on the determined estimation for the energy, determine an additional number of repetitions of the data packet.

According to another aspect there is provided a system comprising means for receiving a data packet from an access node, combining the received data packet with previous repetitions of the data packet to obtain a combined data packet, attempting to decode information comprised in the combined data packet, determining that the attempt to decode was not successful, determining an estimate of energy required for a correct reception of the data packet and based, at least partly, on the determined estimation for the energy, determining an additional number of repetitions of the data packet.

According to another aspect there is provided a computer program product readable by a computer and, when executed by the computer, configured to cause the computer to execute a computer process comprising receiving a data packet from an access node, combining the received data packet with previous repetitions of the data packet to obtain a combined data packet, attempting to decode information comprised in the combined data packet, determining that the attempt to decode was not successful, determining an estimate of energy required for a correct reception of the data packet and based, at least partly, on the determined estimation for the energy, determining an additional number of repetitions of the data packet.

According to another aspect there is provided a computer program product comprising computer-readable medium bearing computer program code embodied therein for use with a computer, the computer program code comprising code for performing receiving a data packet from an access node, combining the received data packet with previous repetitions of the data packet to obtain a combined data packet, attempting to decode information comprised in the combined data packet, determining that the attempt to decode was not successful, determining an estimate of energy required for a correct reception of the data packet and based, at least partly, on the determined estimation for the energy, determining an additional number of repetitions of the data packet.

According to another aspect there is provided a computer program product comprising instructions for causing an apparatus to perform at least the following: receive a data packet from an access node, combine the received data packet with previous repetitions of the data packet to obtain a combined data packet, attempt to decode information comprised in the combined data packet, determine that the attempt to decode was not successful, determine an estimate of energy required for a correct reception of the data packet and based, at least partly, on the determined estimation for the energy, determine an additional number of repetitions of the data packet.

According to another aspect there is provided a computer readable medium comprising program instructions for causing an apparatus to perform at least the following: receive a data packet from an access node, combine the received data packet with previous repetitions of the data packet to obtain a combined data packet, attempt to decode information comprised in the combined data packet, determine that the attempt to decode was not successful, determine an estimate of energy required for a correct reception of the data packet and based, at least partly, on the determined estimation for the energy, determine an additional number of repetitions of the data packet.

According to another aspect there is provided a computer program comprising instructions for causing an apparatus to perform at least the following: receive a data packet from an access node, combine the received data packet with previous repetitions of the data packet to obtain a combined data packet, attempt to decode information comprised in the combined data packet, determine that the attempt to decode was not successful, determine an estimate of energy required for a correct reception of the data packet and based, at least partly, on the determined estimation for the energy, determine an additional number of repetitions of the data packet.

According to another aspect there is provided a non-transitory computer readable medium comprising program instructions for causing an apparatus to perform at least the following: receive a data packet from an access node, combine the received data packet with previous repetitions of the data packet to obtain a combined data packet, attempt to decode information comprised in the combined data packet, determine that the attempt to decode was not successful, determine an estimate of energy required for a correct reception of the data packet and based, at least partly, on the determined estimation for the energy, determine an additional number of repetitions of the data packet.

### LIST OF DRAWINGS

In the following, the invention will be described in greater detail with reference to the embodiments and the accompanying drawings, in which

FIG. 1 illustrates an exemplary embodiment of a radio access network.

FIG. 2 illustrates an exemplary embodiment of handling link budget and RTT in an NTN environment.

FIG. 3 illustrates a flow chart according to an exemplary embodiment.

FIG. 4 illustrates an exemplary embodiment of a formulation.

FIG. 5 illustrates an exemplary embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

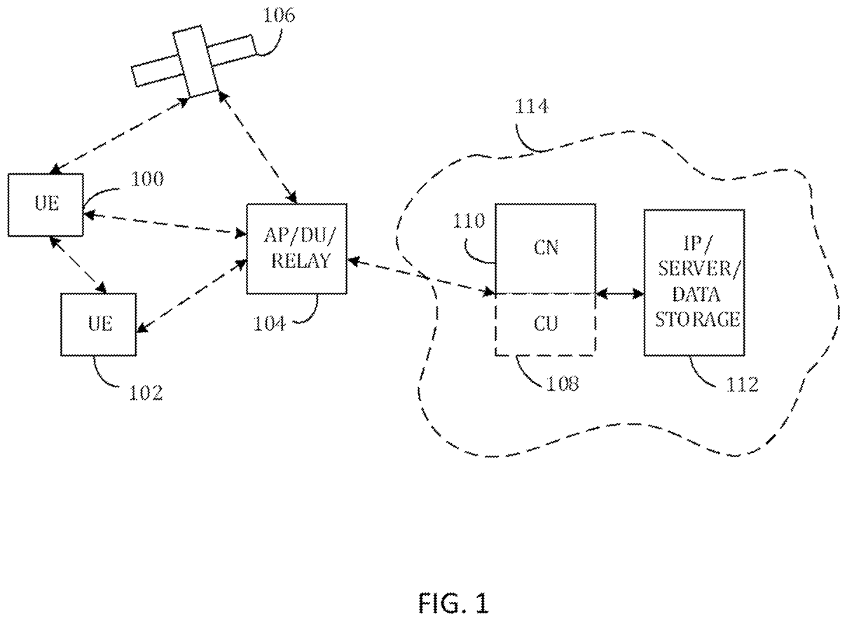

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require to bring the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed.

(or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Possible use cases comprise providing service continuity for machine-to-machine (M2M) or Internet of Things (IoT) devices or for passengers on board of vehicles, and/or ensuring service availability for critical communications, and/or future railway/maritime/aeronautical communications. Satellite communication may utilise geostationary earth orbit (GEO) satellite systems, but also low earth orbit (LEO) satellite systems, for example, mega-constellations (systems in which hundreds of (nano)satellites are deployed). A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized. HAPS may be understood as radio stations located on an object at an altitude of 20-50 kilometres and at a fixed point relative to the Earth. Alternatively, HAPS may also move relative to the Earth. For example, broadband access may be delivered via HAPS using lightweight, solar-powered aircraft and airships at an altitude of 20-25 kilometres operating continually for several months for example.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

A non-terrestrial network may refer to a network, or a segment of networks, using radio frequency, RF, resources in a satellite or an unmanned aircraft system, UAS. The satellite or UAS may provide service, for example NR service, on Earth via one or more satellite beams and one or more cells, for example NR cells, over a given service area bounded by the field of view of the satellite. There may be a service link, i.e. a radio link, between the satellite and one or more terminal devices within the targeted service area. Furthermore, there may be a feeder link, i.e. a radio link, between the satellite and one or more satellite gateways. The satellite gateway may connect the satellite for example to a public data network. gNB functionality may be comprised for example in the satellite, the gateway, and/or in the data network may comprise access node functionalities, for example gNB functionalities. Non-terrestrial network, NTN, may be supported by 5G standards. For example, a 5G access node, a gNB, may be deployed on board satellites to allow coverage to areas such as those that might otherwise not be covered by a cellular communication network. This may enable 5G signals to be beamed down from space thereby enhancing the terrestrial infrastructure of a wireless communication network. It may also help to improve reliability of wireless communication during disasters such as earthquakes that may damage the terrestrial access nodes for example. It is to be noted that in some alternative embodiments the gNB may be located on ground and have a backhaul connection through the satellite.

Various types of satellites exist. For example, some satellites have been in orbit for decades and may operate 36 000 kilometres above the Earth. Some satellites are considered as Low Earth Orbit, LEO, satellites. Such satellites may operate between 500 and 2000 kilometres above the Earth. Some LEO satellites operate at approximately 600 kilometres above the Earth. A low orbit allows latency to be reduced as the satellite may be in a position that enables to quickly receive and transmit data.

Internet of things, IoT, may be understood as a network of physical objects that are connected to each other and/or the Internet. The physical objects may be apparatuses, that may also be called as IoT devices, that connect to each other using for example cellular communication network. Such apparatuses may be imbedded for example into mobile devices, industrial equipment, environmental sensors and medical devices. Further, such apparatuses may comprise various sensors that produce data related to the respective apparatus that may then be provided to other apparatuses and therefore the apparatuses may be understood to be the things of the IoT. The apparatuses comprised in the IoT may be used to provide an interface between the surrounding physical environment and a digital environment. The apparatuses may have various technical capabilities and some apparatuses used for IoT may be low-cost apparatuses that have limited hardware resources for example.

Cellular communication networks may be utilized for connectivity between apparatuses used in an IoT environment. For example, narrow-band IoT, NB-IoT, is a cellular standard for low-power wide-area, LPWA, machine to machine networks. NB-IoT may be used for low-throughput, delay-tolerant applications, such as meters and sensors. NB-IoT may be deployed for example within an existing LTE band, in guard-band between two regular LTE carriers, or in standalone mode. Also enhanced machine-type communication, eMTC, may be used for IoT and it is optimized lower complexity and/or power, deeper coverage, and higher device density. eMTC may seamlessly coexist with other cellular network services such as regular mobile broadband. It is envisaged that NB-IoT and eMTC may utilize NTN as well.

A link budget may be understood as a calculation of total gain and loss in the system to conclude the received signal level at the receiver. The receiver may be a terminal device, which may be for example an apparatus used for IoT or any other suitable terminal device such as a mobile phone. The received signal level is then compared to the receiver sensitivity to check if the channel status is pass or fail. The channel status may be determined to be pass if the received signal level better than the reception sensitivity, otherwise it may be determined to be fail. A link budget may take into account an attenuation of a transmitted signal due to propagation, antenna gain, feeder/cable losses, and other losses. Also, amplification of the signal at a terminal device may be taken into account. If NTN is utilized, the link budget from a satellite may be considerably worse than in a terrestrial network due to a transmission point located high in the sky. Yet, the receiving terminal device, such as an apparatus for lot may have limited hardware resources due to the apparatus being a low-cost apparatus.

Round trip time, RTT, may be understood as the time it takes for a transmitted data packet to be transmitted to its destination and the time it takes for an acknowledgment of that data packet to be received. However, if NTN is utilized, the RTT may increase when compared to RTT in a terrestrial network and thus feedback loops may become slow. Table 1 below illustrates distances and their corresponding one-way delays of different satellite categories.

TABLE 1

| | | LEO at 600 km | | LEO at 1500 km | | MEO at 10000 km | |
|---|---|---|---|---|---|---|---|
| Elevation | | Distance | Delay | Distance | Delay | Distance | Delay |
| angle | Path | D (km) | (ms) | D (km) | (ms) | D (km) | (ms) |
| UE: 10° | satellite - UE | 1932.24 | 6.440 | 3647.5 | 12.158 | 14018.16 | 46.727 |
| GW: 5° | satellite - | 2329.01 | 7.763 | 4101.6 | 13.672 | 14539.4 | 48.464 |
| | gateway | | | | | | |
| 90° | satellite - UE | 600 | 2 | 1500 | 5 | 10000 | 33.333 |

Bent pipe satellite (gNB on Earth, satellite acts as relay)

| | | | | | | | |
|---|---|---|---|---|---|---|---|
| One way | Gateway- | 4261.2 | 14.204 | 7749.2 | 25.83 | 28557.6 | 95.192 |
| delay | satellite_UE | | | | | | |
| Round Trip | Twice | 8522.5 | 28.408 | 15498.4 | 51.661 | 57115.2 | 190.38 |
| Delay | | | | | | | |

Regenerative satellite (gNB onboard the satellite)

| | | | | | | | |
|---|---|---|---|---|---|---|---|
| One way | Satellite - UE | 1932.24 | 6.44 | 3647.5 | 12.16 | 14018.16 | 46.73 |
| delay | | | | | | | |
| Round Trip | Satellite- UE- | 3864.48 | 12.88 | 7295 | 24.32 | 28036.32 | 93.45 |
| Delay | Satellite | | | | | | |

To achieve the long range applicable for example to NB-IOT, repetitions of the encoded payload are utilized to ensure sufficient energy is obtained in the receiving terminal device. NB-IoT allows repetitions for example up to 2048 repetitions in downlink and up to 128 repetitions in uplink. In some exemplary embodiments, coverage enhancement, CE, levels may be configured. An impact of the different CE levels is that transmitted messages are to be repeated several times depending on the location of the terminal device, in other words, depending on the current CE level. The number of repetitions may be enhanced further in NTN context to address the issue of potentially poor link budget. Also, in NTN the time between the terminal device sending an ACK/NACK and RAN receiving it, may considerably longer than in terrestrial networks due to the longer RTT. This may lead to stalling as the access node may not be able to transmit a next transport block size, TBS, for the respective hybrid automatic repeat request, HARQ, process before it knows whether the previous TBS was correctly received or not. A transport block, TB, may be understood as the payload that is passed between the MAC and Phy Layers for the shared data channel such as PDSCH and PUSCH. An apparatus receiving data on the PDSCH determines the TBS before attempting to decode the data. The probability for stalling to occur may be increased due to for example the terminal device having limited hardware resources need to be cheap, and there may be an option of having a limited number of HARQ processes with a minimum of 1 HARQ process.

To address the issue of link budget and prolonged RTT in an NTN, a terminal device may transmit a conditional acknowledgement, ACK, after receiving z amount out of scheduled x amount of repetitions of a certain transport block. In this conditional ACK the terminal device may indicate the number of required repetitions, y, in addition to the z repetitions received in order to receive the transport block correctly. The access node may then transmit the y repetitions in addition to the z repetitions already transmitted and then assume the TB to be received correctly by the terminal device. This way stalling may be avoided. It is to be noted that z+y may be smaller or larger than x. However, the terminal device may then have to estimate the number of repetitions required for a transport block to be received correctly.

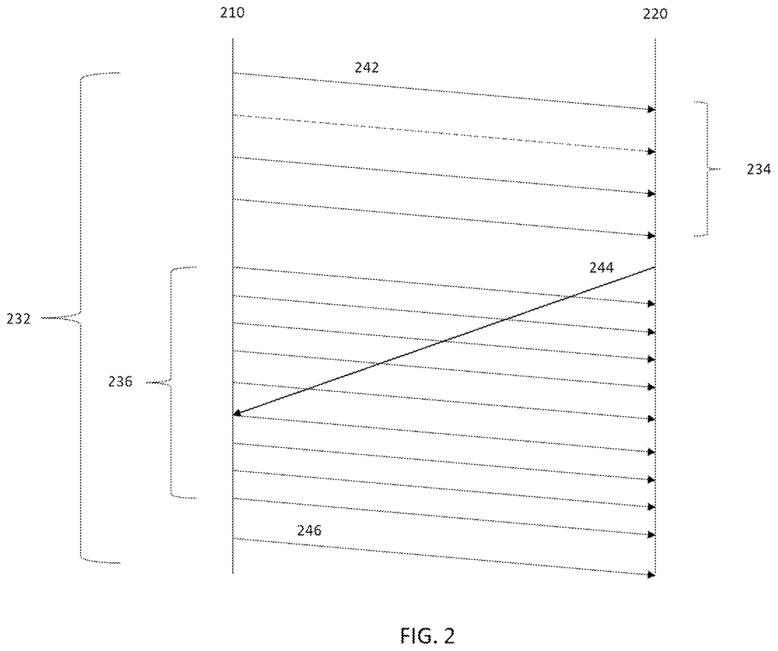

FIG. 2 illustrates an exemplary embodiment of handling link budget and RTT in an NTN environment. The access node 210 schedules repetitions of a TB 242 to be transmitted to a terminal device 220. In total there is an x amount of repetitions 232 to be transmitted. After the terminal device 220 has received z repetitions 234, the terminal device transmits to the access node 210 an indication 244 indicating the amount of repetitions 236 required in order to successfully receive the TB.

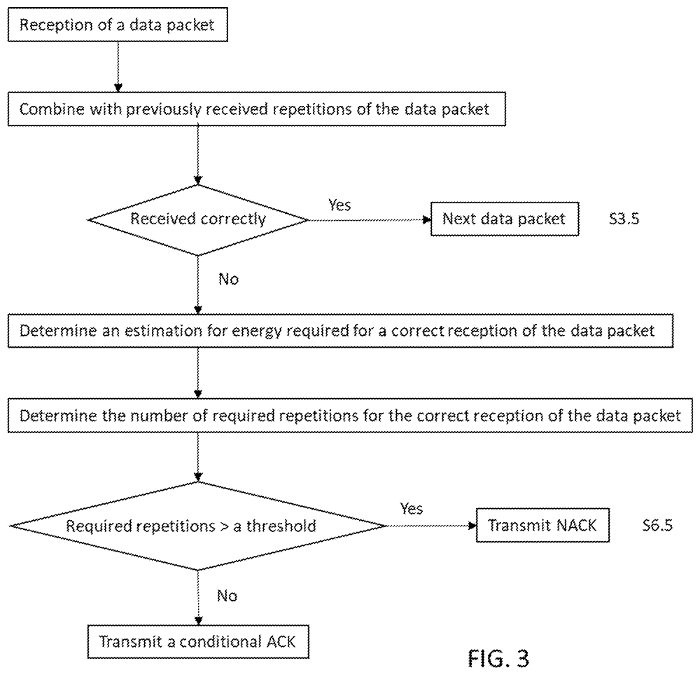

FIG. 3 illustrates a flow chart according to an exemplary embodiment. In this exemplary embodiment, the amount of repetitions required for a successful reception of a data packet, that in this exemplary embodiment is a transmission block, is estimated. A successful reception of a data packet, such as a transmission block, may be considered as correct reception of the data packet. Correct reception may be understood as successful decoding of the received data packet. The decoding may be understood as successful for example when it is decoded without error. First, in S1, a terminal device receives the data packet. The received data packet is received as part of a scheduled number of repetitions of the data packet. The data packet is received from an access node that in this exemplary embodiment is a gNB that is comprised, at least party, in a satellite. The terminal device may be any suitable apparatus such as an IoT apparatus or a mobile phone.

Next, in S2, the received data is combined, by the terminal device, with previous repetitions of the scheduled number of repetitions of the data packet that are received by the terminal device. The combination may then be utilized as soft information on bit level. A soft information may be understood as information obtained by identifying actual transmitted symbol bits and assigning to each bit a level of confidence in the format of a soft value. The combination may be understood as a combined data packet.

The terminal device then proceeds, in S3, to decoding information comprised in the combined data packet. In this exemplary embodiment the decoding is performed at every reception, but in some other exemplary embodiments, the decoding may be performed every n-th repetition and/or before there is a transmission gap and/or before an uplink grant is scheduled.

In S3 it is determined if the decoding has been successfully performed. If yes, then the next data packet may be transmitted by the access node as illustrated in S3.5. The terminal device may then, in this exemplary embodiment, transmit a conventional ACK, move the correctly received data packets to the higher layers, flush the buffers and wait for the next data packet from the access node.

If it is determined in S3 that the decoding has not been successfully performed, then the terminal device determines an estimation for required energy for correct reception in S4. The estimation may be determined, by the terminal device, based on the average level of soft information and a standard deviation across the bits, combined with information about the coding level. The terminal device may then estimate an amount of extra soft information and/or energy required for a correct reception of the data packet. The estimation may be obtained using the formulation below

ΔEnergy=f(meanSoftInformation,stdSoftInformation,codingrate).

In the formulation meanSoffinformation is the average level of the soft information bits, stdSoftInformation is a measure for the standard deviation and codingrate is the coding rate. The average level used for the evaluation may be represented by amplitude, energy or power levels.

Then in S5 the number of repetitions required for a successful reception of the data packet may be determined based on the required energy determined in S4. When determining the amount or repetitions required, the terminal device may perform the determination based, at least partly, on one or more of the following: an amount of extra energy achieved per repetition during previous steps, which may be expressed for example as the average extra soft information per bit obtained per repetition and the changes in path loss that are predictable, for example movements of the satellites in the NTN.

Once the number of further required repetitions is determined, then, in S6, it is determined if the number of required repetitions is greater than a pre-determined threshold amount of repetitions. If it is, then the terminal device transmits a negative acknowledgement, NACK, to the access node as illustrated in S6.5. If, however, it is determined that the number of required repetitions is less than the pre-determined threshold amount of repetitions, the terminal device transmits a conditional acknowledgement, ACK. The conditional ACK may be understood as an ACK that is associated with information regarding further repetitions required for a successful reception of the data packet.

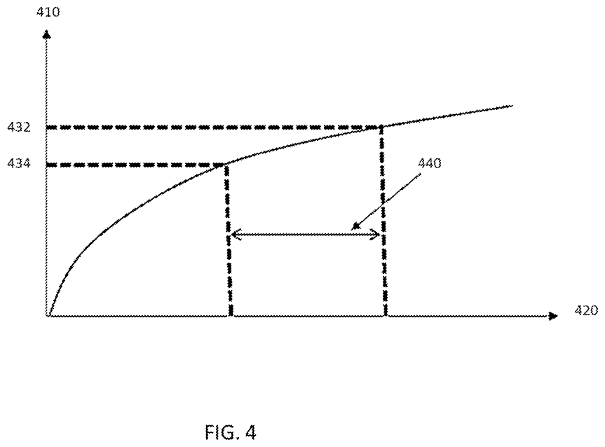

FIG. 4 illustrates an exemplary embodiment of a formulation that may be used for determining an estimation of energy require for successful reception of a data packet, such as discussed above. The y-axis 410 is the energy level and the x-axis 420 is the number of repetitions to be received by the terminal device. The pre-determined threshold 432 and the received number of repetitions 434 are illustrated as well as their deviation 440 which corresponds to the number of repetitions required for successfully receiving the data packet.

The function illustrated in FIG. 4 may be pre-determined and it may be obtained using a table that may be built using for example link simulations and/or by utilizing historical data of previous receptions of data packets. As hardware and/or software resources available for terminal devices differ, the exact function may differ from receiver to receiver. Yet, in this exemplary embodiment, the terminal device utilizes information from previously received data packets and based, at least partly, on information from the previously received data packets, obtains parameters indicating potential need for additional energy or additional repetitions to be received. In some exemplary embodiment, additionally with an offset in time to take into account the signalling delays between the terminal device and the access node. Also, in some exemplary embodiments, for determining if a data packet has been correctly received or not after the determined amount of extra repetitions a threshold, that may be pre-determined, may be utilized. The threshold may be for example a likelihood of a NACK of 0.1% that will be seen as an ACK. This threshold may be based on for example an internal setting of the terminal device and/or it may be set by the access node and made depending on the QoS attributes of the bearer the data packet, which may be a TB, belongs to. Table 2 below illustrates an example of a table that may be utilized for building a function such as the function illustrated in FIG. 4.

TABLE 2

| Coding | | Mean | STD | Received |
|---|---|---|---|---|
| Rate | Soft Bits | Soft Bits | soft bits | correctly |
| ⅓ | 10 0 9 1 10 2 10 10 2 1 | 5.5 | 4.6 | YES |
| ⅓ | 5 5 5 5 5 5 5 5 5 5 5 | 5 | 0 | NO |
| ⅓ | 0 5 1 8 2 0 0 9 10 3 | 4.8 | 4.1 | YES |
| 0.9 | 6 7 5 10 6 10 9 10 8 | 7.9 | 1.9 | YES |
| 0.9 | 10 0 9 1 10 2 10 2 1 | 5.5 | 4.6 | NO |

Table 2 above illustrates examples of combinations which lead to correct and non-correct reception of a data packet such as TB. In the Table the following can be seen: Coding rate, which comprises information regarding how many errors can be corrected. The coding rate may map to a combination of required mean level and STD of soft information to ensure correct reception. The soft bits are also illustrated in Table 2 and those are illustrated, in this exemplary embodiment, as positive numbers such that 0 corresponds to totally unclear whether the bit is a 0 or 1 and 10 corresponds to a good understanding whether the bit is a 0 or 1. The mean and standard deviation, STD, are also included. Table 2 also comprises examples of correct and not correct reception of the data packet. For example, at the coding rate 1/3 it is determined that a high variance is good for correct decoding, as the mean of 4,8 may be correctly received due to a high STD, while the second row with a mean of 5 is not correctly received. Further, it is also illustrated that when a higher coding rate is utilized, as illustrated in the last two rows, a high standard deviation across the bits may not be helping as much as the higher coding rate means not many bits can be corrected.

Determining the required number of further repetitions for successfully receiving a transmitted data packet, as illustrated for example in S5 of FIG. 3, the following equation may be utilized:

y=ΔEnergy/(Energy_repetitiony(LEO)).

In the equation above Energy_repetition is the energy achieved per repetition, which may be calculated from past samples based on the average amount of extra soft information per bit, and f(LEO) is a function reflecting the path loss changes over time and/or repetition.

In some exemplary embodiments soft information may be utilized as soft input to a decoder. For example, the soft input may be used as soft channel output, soft demapper output and/or channel estimation parameters. Additionally, or alternatively, soft information may be utilized as soft output at the decoder for example as log-likelihood ratio. Further additionally or alternatively, soft information may be utilized as probability information, also known as reliability or weight, for example as a probability of a bit being 0 or 1.

It is to be noted that the exemplary embodiments described above any IoT or mobile broadband service utilizing NTN. The exemplary embodiments described above may have the advantage of enabling a conditional acknowledgement. The exemplary embodiments described above may also have advantages such as reducing stalling, increasing throughput for example from a few percentages to 400 percentages, enabling a terminal device to transfer data faster and/or reducing power consumption.

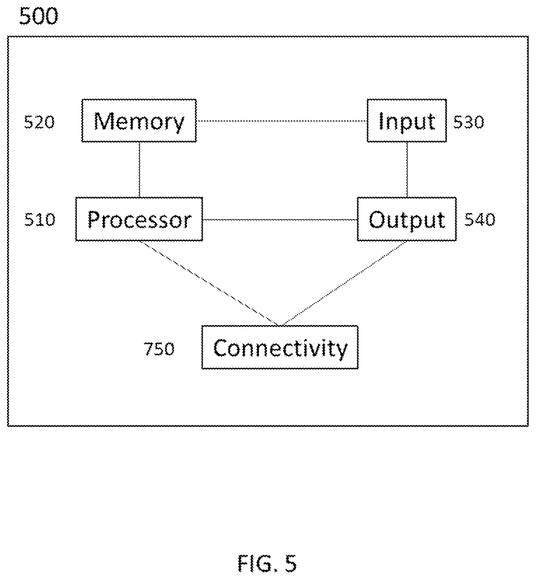

FIG. 5 illustrates an apparatus 500, which may be an apparatus such as, or comprised in, a terminal device, according to an example embodiment. The apparatus 500 comprises a processor 510. The processor 510 interprets computer program instructions and processes data. The processor 510 may comprise one or more programmable processors. The processor 510 may comprise programmable hardware with embedded firmware and may, alternatively or additionally, comprise one or more application specific integrated circuits, ASICs.

The processor 510 is coupled to a memory 520. The processor is configured to read and write data to and from the memory 520. The memory 520 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 520 stores computer readable instructions that are execute by the processor 510. For example, non-volatile memory stores the computer readable instructions and the processor 510 executes the instructions using volatile memory for temporary storage of data and/or instructions.

The computer readable instructions may have been pre-stored to the memory 520 or, alternatively or additionally, they may be received, by the apparatus, via electromagnetic carrier signal and/or may be copied from a physical entity such as computer program product. Execution of the computer readable instructions causes the apparatus 500 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 500 further comprises, or is connected to, an input unit 530. The input unit 530 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 530 may comprise an interface to which external devices may connect to.

The apparatus 500 also comprises an output unit 540. The output unit comprises or is connected to one or more displays capable of rendering visual content such as a light emitting diode, LED, display, a liquid crystal display, LCD and a liquid crystal on silicon, LCoS, display. The output unit 540 may further comprise one or more audio outputs. The one or more audio outputs may be for example loudspeakers or a set of headphones.

The apparatus 500 may further comprise a connectivity unit 550. The connectivity unit 550 enables wired and/or wireless connectivity to external networks. The connectivity unit 550 may comprise one or more antennas and one or more receivers that may be integrated to the apparatus 500 or the apparatus 500 may be connected to. The connectivity unit 550 may comprise an integrated circuit or a set of integrated circuits that provide the wireless communication capability for the apparatus 500. Alternatively, the wireless connectivity may be a hardwired application specific integrated circuit, ASIC.

It is to be noted that the apparatus 500 may further comprise various component not illustrated in the FIG. 5. The various components may be hardware component and/or software components.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory storing instructions that, when executed by the at least one processor, cause the apparatus to:
receive a data packet from an access node;
combine the received data packet with previous repetitions of the data packet to obtain a combined data packet;
attempt to decode information comprised in the combined data packet;
determine that the attempt to decode was not successful; and
determine an estimate of energy required for a correct reception of the data packet and based, at least partly, on the determined estimation for the energy, determine an additional number of repetitions of the data packet.

2. An apparatus according to claim 1, wherein the apparatus is further caused to transmit a conditional acknowledgement if the number of repetitions of further transmissions of the data packet required exceeds a pre-determined threshold value.

3. An apparatus according to claim 2, wherein the conditional acknowledgement is an acknowledgement comprising information regarding the number of repetitions of further transmissions of the data packet.

4. An apparatus according to claim 1, wherein the data packet is a downlink data packet scheduled and transmitted by the access node and the scheduling of the data packet comprises a plurality of repetitions of transmitting the data packet.

5. An apparatus according to claim 1, wherein the apparatus is further caused to determine the estimation for energy required based, at least partly, on an average level of soft information bits, a standard deviation of the soft bits and on packet coding rate.

6. An apparatus according to claim 1, wherein determining the number of repetitions of further transmissions of the data packet required is further based on predictable changes in path loss.

7. An apparatus according to claim 1, wherein the estimation for the energy required is determined based, at least partly, on link simulations, an average extra soft bit information per bit obtained per repetition or previous successful receptions of other data packets.

8. An apparatus according to claim 1, wherein the apparatus is caused to decode the information comprised in the combined data packet at every repetition, at certain pre-determined repetitions of receiving the data packet, before a transmission gap or before an uplink grant is scheduled.

9. An apparatus according to claim 1 wherein the access node is comprised, at least partly, in a satellite or signals from the access node are relayed through the satellite.

10. An apparatus according to claim 1 wherein the apparatus is a terminal device.

11. A method comprising:
receiving a data packet from an access node;
combining the received data packet with previous repetitions of the data packet to obtain a combined data packet;
attempting to decode information comprised in the combined data packet;
determining that the attempt to decode was not successful; and
determining an estimate of energy required for a correct reception of the data packet and based, at least partly, on the determined estimation for the energy, determining an additional number of repetitions of the data packet.

12. A non-transitory computer readable medium comprising program instructions that, when executed by an apparatus, cause the apparatus to perform at least the following:
receive a data packet from an access node;
combine the received data packet with previous repetitions of the data packet to obtain a combined data packet;
attempt to decode information comprised in the combined data packet;
determine that the attempt to decode was not successful; and
determine an estimate of energy required for a correct reception of the data packet and based, at least partly, on the determined estimation for the energy, determine an additional number of repetitions of the data packet.

13.-15. (canceled)

16. A method according to claim 11, wherein the method further comprises transmitting a conditional acknowledgement if the number of repetitions of further transmissions of the data packet required exceeds a pre-determined threshold value.

17. A method according to claim 16, wherein the conditional acknowledgement is an acknowledgement comprising information regarding the number of repetitions of further transmissions of the data packet.

18. A method according to claim 11, wherein the data packet is a downlink data packet scheduled and transmitted by the access node and the scheduling of the data packet comprises a plurality of repetitions of transmitting the data packet.

19. A method according to claim 11, wherein the method further comprises determining the estimation for energy required based, at least partly, on an average level of soft information bits, a standard deviation of the soft information bits and on packet coding rate.

20. A method according to claim 11, wherein determining the number of repetitions of further transmissions of the data packet required is further based on predictable changes in path loss.

21. A method according to claim 11, wherein the estimation for the energy required is determined based, at least partly, on link simulations, an average extra soft bit information per bit obtained per repetition or previous successful receptions of other data packets.

22. A method according to claim 11, wherein the method further comprises decoding the information comprised in the combined data packet at every repetition, at certain pre-determined repetitions of receiving the data packet, before a transmission gap or before an uplink grant is scheduled.

23. A method according to claim 11 wherein the access node is comprised, at least partly, in a satellite or signals from the access node are relayed through the satellite.
